(19) United States
(12) Patent Application Publication
(10) Pub. No.: US 2022/0307467 A1
(43) Pub. Date: Sep. 29, 2022

(54) TURBINE ALIGNMENT BY USE OF LIGHT POLARISING COMPASS

(71) Applicant: Vestas Wind Systems A/S, Aarhus N. (DK)

(72) Inventor: Gustavo Oliveira Violato, Risskov (DK)

(21) Appl. No.: 17/619,662

(22) PCT Filed: Jun. 16, 2020
(86) PCT No.: PCT/DK2020/050171

§ 371 Date: Dec. 16, 2021

(30) Foreign Application Priority Data
Jun. 21, 2019 (DK) PA 2019 70394

(51) Int. Cl. F03D 7/02; F03D 7/04; G01C 17/34; G01C 17/38

(52) U.S. Cl. CPC F03D 7/0204; F03D 7/048; G01C 17/34; G01C 17/38; F05B 2270/329; F05B 2270/802; F05B 2260/84

(57) ABSTRACT

The present invention provides a method of estimating an orientation of a wind turbine. The method comprises determining, using a polarising light compass of the wind turbine, a sun polarisation value, and determining a yaw angle of the wind turbine associated with the sun polarisation value. A sun direction vector is determined based on the sun polarisation value and the associated yaw angle; and an orientation of the wind turbine is estimated relative to a fixed direction using the sun direction vector.

### FIELD OF THE INVENTION

The present invention relates to wind turbine control, and in particular it relates to estimating an orientation of a wind turbine.

### BACKGROUND OF THE INVENTION

Wind turbines typically seek alignment with average wind direction over a certain period of time. To align a wind turbine to a given direction, it is necessary to know the orientation of the wind turbine. However, installation and inherent instrument errors lead to a scatter of turbine alignments within a wind park, which may negatively affect the park's energy output. Moreover, a new wind park control technique may benefit from knowing each wind turbine's orientation with respect to other turbines, with some precision and in a robust yet cheap way.

Conventional methods for turbine alignment vary from rough alignment using a hand compass to GPS triangulation/direction inference. These methods require manually operating the wind turbine to input correction factors to the control system; this is prone to human errors and results in extended downtime for the wind turbines. In addition, measurements of wind turbine alignments are generally subject to drift as the wind turbine operates unless the same correction procedure is applied periodically.

### SUMMARY OF THE INVENTION

In a first aspect, there is provided a method of estimating an orientation of a wind turbine, the method comprising:
determining, using a polarising light compass of the wind turbine, a sun polarisation value;
determining a yaw angle of the wind turbine associated with the sun polarisation value;
determining a sun direction vector based on the sun polarisation value and the associated yaw angle; and
estimating an orientation of the wind turbine relative to a fixed direction using the sun direction vector.

Generating a plurality of sun direction vectors can be based on determining a plurality of sun polarisation values; and wherein the orientation can be estimated using the plurality of sun direction vectors.

Determining the sun direction vector can comprise comparing the sun polarisation value to a solar polarisation model.

Estimating an orientation of the wind turbine can comprise comparing the sun direction vector to an expected trajectory of the sun.

Estimating the orientation of the wind turbine can comprise comparing the sun direction vector to previous sun direction vectors.

Estimating the orientation of the wind turbine can be further based on a measurement time associated with the sun polarisation value and/or a location of the wind turbine.

The method of the first aspect can further comprise: receiving a light intensity measurement associated with the sun polarisation value; comparing the light intensity measurement to a predetermined threshold; and, if the light intensity measurement is less than the predetermined threshold, disregarding the sun polarisation value.

The estimated orientation of the wind turbine can be further based on previously estimated orientations of the wind turbine.

The method of the first aspect can further comprise controlling the wind turbine based on the estimated orientation, wherein controlling the wind turbine based on the estimated orientation can comprise: aligning the wind turbine with a wind direction; and/or aligning the wind turbine with other wind turbines of a wind park, wherein controlling the wind turbine based on the estimated orientation can comprise: predicting an area of shadow cast by the wind turbine based on wind turbine location, and the location of the sun; and suspending operation of the wind turbine if the predicted wind turbine shadow falls within a restricted area.

Determining the sun polarisation value can comprise: detecting sunlight through a first polarisation filter and a second polarisation filter, wherein the first polarisation filter and the second polarisation filter can have a fixed angle between them; and can compare the sunlight detected through the first polarisation filter to the sunlight detected through the second polarisation filter.

In a second aspect, there is provided a method of controlling a wind park, the wind park comprising a plurality of wind turbines, each wind turbine having a polarising light compass, the method comprising:
estimating an orientation relative to a fixed direction of each wind turbine of the plurality of wind turbines using the method of any preceding claim; and
aligning the plurality of wind turbines based on the estimated relative orientation of each wind turbine.

The second aspect may comprise all alternatives of the first aspect.

In a third aspect, there is provided a method of calibrating a yaw angle of a wind turbine, the method comprising:
determining, using a polarising light compass of the wind turbine, a sun polarisation value at a measurement time;
determining an expected polarisation value based on an expected position of the sun at the measurement time;
comparing the measured sun polarisation value to the expected polarisation value;
determining a yaw angle of the wind turbine based on the comparison of the measured sun polarisation vector and expected polarisation value; and
comparing the determined yaw angle to a yaw angle generated by a yaw encoder of the wind turbine.

The third aspect can comprise all alternatives of the first and second aspects.

In a fourth aspect, there is provided a wind turbine control system, the system comprising:
a yaw sensor encoder configured to output a current yaw angle;
a polarising light compass configured to generate a sun polarisation value; and
a wind turbine controller communicatively connected to the polarising light compass and the yaw sensor encoder,
wherein the wind turbine controller is configured to perform the method of any previous aspect and its alternatives.

In a fifth aspect, there is provided a wind turbine comprising the wind turbine control system of the fourth aspect, the wind turbine comprising:
a nacelle, wherein the polarising light compass is fixed to the external surface of the nacelle.

In a sixth aspect, there is provided a computer program product comprising software code adapted to control a wind turbine when executed on a data processing system, the computer program product being adapted to perform the method of any of aspects one to three and their alternatives.

The computer program product may be provided on a computer readable storage medium or may be downloadable from a communication network. The computer program product may comprise instructions which, when executed cause a data processing system, e.g. in the form of a controller, to perform the method of any embodiment of the first, second, or third aspects.

In general, a controller may be a unit or collection of functional units which comprises one or more processors, input/output interface(s) and a memory capable of storing instructions can be executed by a processor.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will now be described with reference to the accompanying drawings, in which:

FIG. 1 illustrates, in a schematic perspective view, an example of a wind turbine.

FIG. 2 schematically illustrates an embodiment of a control system together with elements of a wind turbine.

FIG. 3 illustrates a polarising light compass.

FIG. 4 illustrates the output from the log ratio amplifier as it is rotated 360 degrees around the zenith.

FIG. 5 illustrates a 3D representation of the pattern of polarisation in the sky as experienced by an observer in point O.

FIG. 6 illustrates a flow diagram of a method of estimating an orientation of a wind turbine 10.

FIG. 7 illustrates a flow diagram of an alternative method of estimating an orientation of a wind turbine.

FIG. 8 illustrates a flow diagram of a method of controlling a wind park.

FIG. 9 illustrates a system diagram of a wind turbine control system on or in the vicinity of the wind turbine.

FIG. 10 illustrates a flow diagram of the method of calibrating a yaw angle of the wind turbine.

### DETAILED DESCRIPTION OF EMBODIMENT(S)

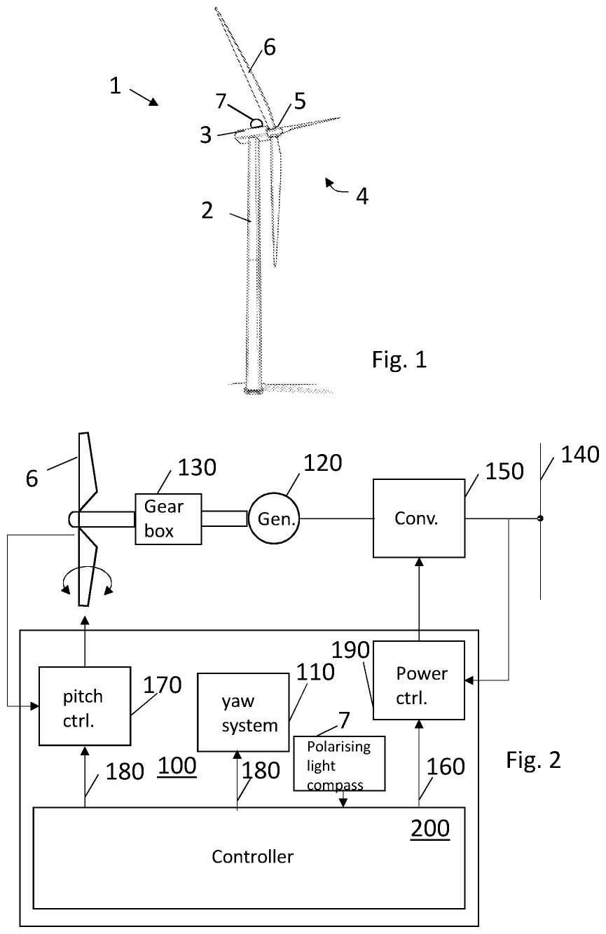

FIG. 1 illustrates, in a schematic perspective view, an example of a wind turbine 1. The wind turbine 1 includes a tower 2, a nacelle 3 at the apex of the tower, and a rotor 4 operatively coupled to a generator housed inside the nacelle 3. In addition to the generator, the nacelle houses miscellaneous components required for converting wind energy into electrical energy and various components needed to operate, control, and optimize the performance of the wind turbine 1. Positioned on top of the nacelle is a polarising light compass 7. The rotor 4 of the wind turbine includes a central hub 5 and a plurality of blades 6 that project outwardly from the central hub 5. In the illustrated embodiment, the rotor 4 includes three blades 6, but the number may vary. Moreover, the wind turbine comprises a control system. The control system may be placed inside the nacelle or distributed at a number of locations inside the turbine and communicatively connected.

The wind turbine 1 may be included among a collection of other wind turbines belonging to a wind power plant, also referred to as a wind farm or wind park, that serve as a power generating plant connected by transmission lines with a power grid. The power grid generally consists of a network of power stations, transmission circuits, and substations coupled by a network of transmission lines that transmit the power to loads in the form of end users and other customers of electrical utilities.

FIG. 2 schematically illustrates an embodiment of a control system 100 together with elements of a wind turbine. The wind turbine comprises rotor blades 6 which are mechanically connected to an electrical generator 120 via gearbox 130. In direct drive systems, and other systems, the gearbox 130 may not be present. The electrical power generated by the generator 120 is injected into a power grid 140 via an electrical converter 150. The electrical generator 120 and the converter 150 may be based on a full scale converter (FSC) architecture or a doubly fed induction generator (DFIG) architecture, but other types may be used.

The control system 100 comprises a number of elements, including at least one main controller 200 with a processor and a memory, so that the processor is capable of executing computing tasks based on instructions stored in the memory. In general, the wind turbine controller ensures that in operation the wind turbine generates a requested power output level. This is obtained by adjusting the pitch angle of the blades 6 and/or the power extraction of the converter 150. To this end, the control system comprises a pitch system including a pitch controller 170 using a pitch reference 180, and a power system including a power controller 190 using a power reference 160. The wind turbine rotor comprises rotor blades that can be pitched by a pitch mechanism. The rotor comprises an individual pitch system which is capable of individual pitching of the rotor blades, and may comprise a common pitch system which adjusts all pitch angles on all rotor blades at the same time. The control system, or elements of the control system, may be placed in a power plant controller (not shown) so that the turbine may be operated based on externally provided instructions.

The control system 100 further comprises a yaw system 110 including a yaw controller and a yaw sensor encoder. The yaw encoder measures the yaw angle of the nacelle 5 of the wind turbine, which can be used by the yaw controller to actuate a motor to turn the nacelle 5 of the wind turbine to face the wind turbine in a particular direction.

The control system 100 further comprises a polarising light compass 7. The polarising light compass 7 measures the polarisation of the light in the sky. In particular, the polarising light compass 7 may indicate the direction of the sun which can be used to calculate true north. Operation of the light polarising compass 7 is described in more detail below.

When the turbine 1 is initially constructed, the yaw of each blade 6 may be manually aligned. This may result in a difference between the yaw angle that control system 20 reports for the nacelle 3, and the actual direction of the nacelle 5. The control system 20 uses yaw to optimise performance of the turbine 1 for current wind conditions. Any mismatch between actual yaw and the reported yaw of the nacelle 3 may result in the turbine 1 performing sub-optimally, reducing the amount of energy than can be extracted from the wind.

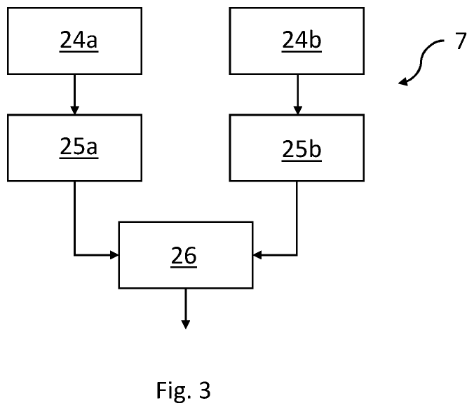

FIG. 3 illustrates a polarising light compass 7. Unlike a regular compass, the polarising light compass 7 doesn't necessarily point north. The output from the polarising light compass 7 is a sun polarisation value which indicates the sun direction with respect to the orientation of the polarising light compass 7. Polarisation in the sky occurs because the sunlight is scattered by atmospheric molecules. The degree of polarisation is greatest for light scattered at an angle of 90 degrees to the sunlight rays. Unlike conventional magnetic compasses, polarising light compass 7 is not dependent on the Earth's magnetic field, which may be disturbed by local sources (e.g. the turbine itself). A polarising light compass 7 is also relatively inexpensive in comparison to other techniques such as GPS triangulation/direction inference. Moreover, a polarising light compass 7 is not adversely affected by shadow flicker (caused by the moving blades 6) or cloud cover.

The polarising light compass 7 comprises a first polarisation filter 24a and a second polarisation filter 24b. The first polarisation filter 24a and the second polarisation filter 24b have a known fixed angle between them; that is to say when sunlight is incident on the two polarisation filters 24a, 24b from the same direction, the intensity of light passing through may be different for each polarisation filter 24a, 24b. Additional filters or detectors may be used to get a more accurate indication of sun direction, and/or further polarising light compasses may be used at differing angles to also improve the accuracy of the system.

The intensity of light which passes through the first polarisation filter 24a can be detected by photodiode 25a. The intensity of light passing through the second polarisation filter 24b can be detected by photodiode 25b. The output signal from each photodiode 25a, 25b is a magnitude which depends on the orientation of the sun to the light polarising compass 7, and the intensity of the incident light.

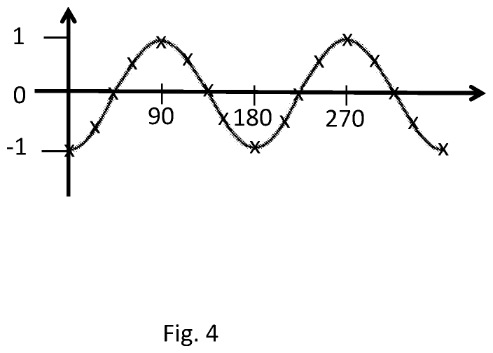

In the illustrated embodiment, the output from each photodiode 25a, 25b is received by a log ratio amplifier 26. The output from the log ratio amplifier 26 may be a signal proportional to the log (Logarithmic function) of the input from the second photodiode 25b minus the log of the first photodiode 25a. As an example of how the polarisation of the sun varies across the sky, FIG. 4 illustrates the output from the log ratio amplifier 26 as it is rotated 360 degrees around the zenith (i.e. if the polarising light compass rotates, whilst the sun stays in a fixed position).

Each sample from the polarising light compass is shown as an X on FIG. 4, assuming that the sun is stationary in the sky. FIG. 4 assumes that the polarizer's 24a, 24b surface is pointing towards the horizon and are rotated around the zenith, and sample is taken every 22.5 degrees of rotation. The period of this variation is 180 degrees, since sunlight is polarised in the same direction whether the compass 7 is aimed directly in the direction of the sun or directly away from the sun's direction.

In an embodiment, the polarising light compass 7 is fixed on a nacelle 3, and thus will not typically be operated in such a way to produce the graph of FIG. 4.

The output from the polarising light compass 7 is not dependent on the intensity of the sun, only on the sun's orientation with respect to the polarising light compass 7. This is because the first and second polarisation filters 24a, 24b are incident with the same (or substantially the same, or known difference in) intensity of sunlight. Thus, the subtraction performed by the log ratio amplifier 26 cancels out the part of the signal responsible for sunlight intensity. This has the advantage of being used in low light, or cloudy conditions, or when the sun is not visible.

The sun, however, moves through the sky throughout the day and throughout the year, rather than being stationary as in FIG. 4. Thus, the azimuth angle of the sun with respect to a fixed polarisation light compass 7 will constantly vary. Moreover, the altitude angle of the sun also affects the relative strength of the polarisation (which is weakest when the sun's light is perpendicular the surface of the polarising filters, and strongest when the sun's light is parallel the surface of the polarising filters). Thus, the altitude angle of the sun with respect to a fixed polarisation light compass 7 will constantly vary also.

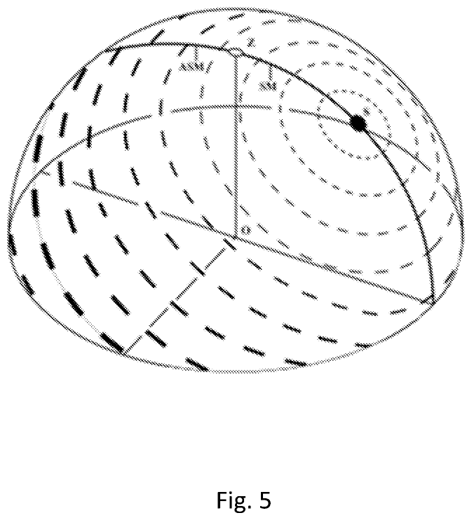

FIG. 5 illustrates a 3D representation of the pattern of polarisation in the sky as experienced by an observer at point O. The polarisation of the sky is dependent on the celestial position of the sun. In particular, it shows how the strength of the polarisation varies in the azimuth angle and the altitude angle of the sun in the sky. Orientation and width of the bars depict the direction and degree of polarisation respectively. A prominent property of the pattern is a symmetric line running through the solar S and zenith Z called solar meridian on the side of the sun and anti-solar meridian on the opposite side. This results in the 180 period of graph shown in FIG. 4.

A resource for further reading on polarising light compasses is ‘a mobile robot employing insect strategies for navigation’ by Lambrinos et al. (DOI: 10.1.1.107.916) although the method of use does vary in comparison to the present application.

In summary, the output of the polarising light compass 7 varies with the orientation of the polarising light compass 7, and with the position of the sun in the sky throughout the day and year. By placing a polarising light compass 7 on the nacelle of a wind turbine 1, a further variable, the yaw angle of the wind turbine needs to be accounted for in order to get an accurate estimation of the orientation of the wind turbine 1.

The present invention provides a method of estimating an orientation of a wind turbine which incorporates the yaw angle, and so overcomes this complication. The present invention has the benefit of being a cheap and robust way to estimate orientation of the wind turbine accurately, allowing for more accurate control of the wind turbine. This in turn allows for efficiency gains to be made if used in the context of a wind park or a longer operating time if ‘shadow restriction zones’ are present within the vicinity of a single wind turbine.

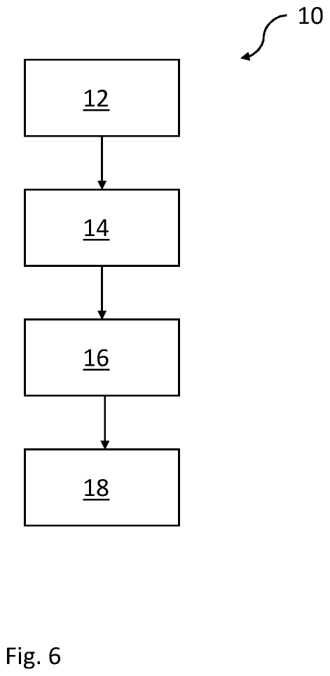

An embodiment of the invention is illustrated in FIG. 6. FIG. 6 illustrates a flow diagram of a method of estimating an orientation of a wind turbine 10.

The method starts at step 12, at which a sun polarisation value is determined using a light polarising compass of the wind turbine.

As discussed above, the sun polarisation value may be the angle of polarisation of sunlight received at the light polarising compass 7 of the wind turbine 1. This value will depend on the position of the sun (and hence time of day, time of year, and geographical location of the wind turbine); on the relative orientation of the wind turbine with respect to a fixed position (e.g. true north), and on the current yaw position of the wind turbine (e.g. with respect to a defined zero-yaw position). In some embodiments, the sun polarisation value may be the output from log ratio amplifier 26 discussed above, which may be a normalised response value such as a value between one and minus one, representing the polarisation angle.

The method then proceeds to step 14, at which the yaw angle of the wind turbine associated with the sun polarisation value is determined. The yaw angle is the current yaw position of the wind turbine (e.g. with respect to a defined zero-yaw position), measured at the same or a similar time to the sun polarisation value.

The method then proceeds to step 16, at which a sun direction vector based on the sun polarisation value and the associated yaw angle is determined. The sun direction vector is a vector which indicates the possible direction of the sun in relation to the polarisation light compass 7. In order to do this the yaw angle and sun polarisation value must be known as described above—as the direction the light polarising compass faces changes depending on the yaw angle of the turbine.

In some embodiments, step 16 of determining the sun direction vector may comprise comparing the sun polarisation value to a solar polarisation model, such as the Raleigh sky model. The solar polarisation model may be used to predict the sun polarisation value for particular solar positions/time of day, such as Raleigh sky model. Determining the sun direction vector may be achieved by applying an algorithm relating yaw angle, sun polarisation value, and optionally time of day to determine direction of sun relative to the turbine (i.e. a fixed angle of the turbine, such as zero yaw angle). For example, algorithm may determine a direction of the sun relative to the polarisation light compass from the polarisation value, and then correct the direction by accounting for yaw angle. Alternatively, determining the sun direction vector may comprise comparing the sun polarisation value to values in a look-up table or any known method known in the art.

Having determined the sun direction vector, the method then proceeds to step 18, at which an orientation of the wind turbine relative to a fixed direction is estimated using the sun direction vector. For example, the sun direction vector can be compared to a known position of the sun to determine the orientation of the turbine. The orientation of the turbine may be defined for example based on the zero-yaw position of the nacelle, or based on any other fixed aspect of the turbine. The fixed direction may be a cardinal or inter cardinal direction such as true north or true south. Alternatively, the fixed direction may be in relation to a fixed direction signifier. The fixed direction can act as a standardised direction in which the yaw or wind turbine functionality can be controlled relative to. This allows for more accurate wind turbine control.

The determined orientation may then be used to control the turbine. For example, knowing an accurate orientation of the turbine may allow more accurate alignment with a prevailing wind.

In some embodiments the step of estimating 18 the orientation of the wind turbine may comprise comparing the sun direction vector to an estimated or expected trajectory of the sun. This may include curve fitting multiple values to an expected trajectory. Alternatively, estimating the orientation of the wind turbine may comprise comparing the sun direction vector to values in a look-up table or any known method known in the art. The step of estimating 18 the orientation of the wind turbine may be performed by an estimation algorithm. Further still, the estimation 18 of the orientation of a wind turbine may be further based on a measurement time associated with the sun polarisation value and/or a location of the wind turbine.

The method 10 may further comprise generating a plurality of sun direction vectors based on the determination of a plurality of sun polarisation values. In an embodiment, one sun polarisation value corresponds to one sun direction vector. In an alternative embodiment, a plurality of sun polarisation values are generated to determine each sun direction vectors. The plurality of sun polarisation values may be measured in a substantially small space of time such that the sun and yaw of the wind turbine remain substantially constant (i.e. many sun polarisation values may be taken within: 5 minutes, 2 minutes, 30 seconds, 10 seconds, and/or 1 second). The plurality of sun polarisation values may be averaged or processed to generate the sun direction vector, this may reduce the measurement noise and make the sun direction vector more accurate.

The orientation of the wind turbine may be estimated using the plurality of the sun direction vectors. The step of estimating using a plurality of the sun direction vectors may be performed by an iterative algorithm or process. This allows previous sun direction vectors to aid and/or improve in the estimation of orientation of the wind turbine by comparing the current sun direction vector to previous sun direction vectors.

In an embodiment, the previous sun direction vectors may be all, or substantially all, of the previous sun direction vectors measured for that wind turbine. The analysis of all of the previous sun direction vectors may be performed by a big data or machine learning algorithm. Such an algorithm may be able to generate a more accurate estimate of the orientation of the wind turbine relative to the fixed direction. In an alternative embodiment, the previous sun direction vectors may be a subset of all of the previous sun direction vectors. The subset of previous sun direction vectors may be: previous sun direction vectors from the corresponding time of day; previous sun direction vectors from the most recent previous few days or weeks; and/or any subset derived from all previous sun direction vectors using a big data or machine learning algorithm. Advantageously, this generates a more accurate estimate of the orientation of the wind turbine relative to the fixed direction.

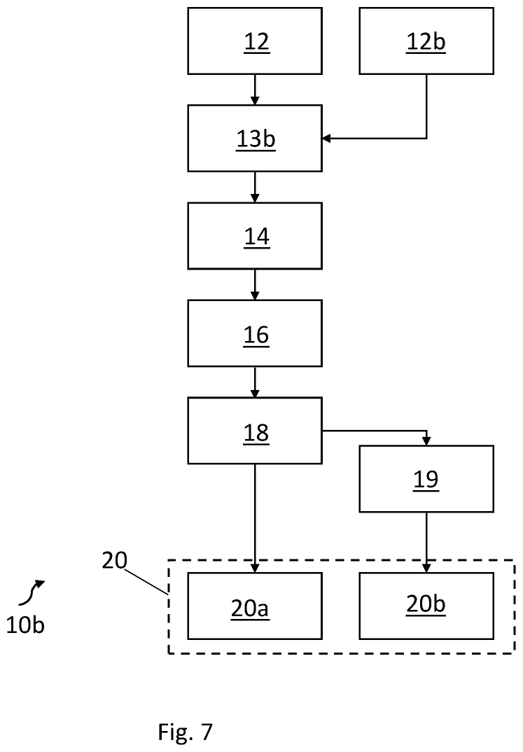

FIG. 7 illustrates a flow diagram of an alternative method 10b of estimating an orientation of a wind turbine. The method 10b incorporates the steps 12, 14, 16, and 18 of the method 10 discussed above, with optional additional steps 12b, 13b, 19, 20a, and 20b. The optional additional steps are independent of one another, so although the illustrated embodiment uses all of the optional additional steps, other embodiments may use only one or any sub-set of the optional additional steps.

An advantage of the method of estimating an orientation of a wind turbine 10, 10b is its ability to accurately operate during times that the sun is not visible in the sky (e.g. due to cloud cover, or due to the rotation of blades 6 momentarily blocking out the sun) from the polarising light compass 7—the compass 7 can still detect polarisation at a different point in the sky, or of the light that does pass through the clouds. However, a reduced sunlight intensity incident of the polarisation light compass 7 may result in a reduced signal to noise ratio at the output of the polarisation light compass 7. To ensure that an accurate estimation of orientation of the wind turbine is still achieved, method 10b includes step 12b of receiving a light intensity measurement associated with the sun polarisation value determined at step 12. The light intensity measurement may be compared at step 13b to a predetermined intensity threshold and if the light intensity measurement is less than the predetermined threshold then the sun polarisation value may be disregarded. Method step 12 may then be repeated, to attempt to measure the polarisation when there is sunlight. For example, method step 12 may be repeated after a predetermined delay, or after receipt of a signal indicating that the light intensity measurement exceeds the threshold. When a polarisation measurement is taken with sufficient light intensity, the method 10b proceeds to steps 14-18, similar to those discussed above.

The predetermined intensity threshold may be that of an overcast day such as 2000 lux. Alternatively, the predetermined intensity threshold may be: 1500 lux; 1000 lux; 500 lux; 250 lux; 175 lux; 100 lux; or 50 lux. A typical value may for example be 400 lux. Alternatively, there may be multiple predetermined intensity thresholds, and below each threshold the sun polarisation value may be weighted less in the estimation of the orientation of the wind turbine relative to the fixed direction.

After the wind turbine orientation is estimated at step 18, the wind turbine 1 may be controlled at step 20 based on the estimated orientation. This may comprise: aligning, at step 20a, the wind turbine with a known direction, such as the wind direction; and/or aligning the wind turbine to a known directions such that it is substantially aligned with other wind turbines of a wind park. Although wind direction within a wind park is not necessarily consistent throughout the wind park, aligning wind turbines in a wind park to each other allows for wind park efficiency gains to be made. The alignment may be calculated using an algorithm capable of substantially maximising the output of the wind park based on the prevailing wind direction and assuming all wind turbines in a wind park are orientated in the same direction.

Alternatively or additionally, at step 19, an area of the shadow cast by the wind turbine may be predicted based on the wind turbine location, and the location of the sun. The step 20 of controlling the wind turbine 1 may then comprise the step 20b of suspending operation of the wind turbine if the predicted wind turbine shadow falls within a restricted area (i.e. a ‘shadow restriction zone’). This may prevent problematic shadow flicker: the effect produced from the blades 6 momentarily blocking out the sun from the perspective of an observer in the shadow of the wind turbine 1. The accuracy of the estimated orientation afforded by the disclosed method allows for a more accurate prediction of the area of the shadow cast by the wind turbine, which allows for reduced wind turbine downtime and thus an increase in power output.

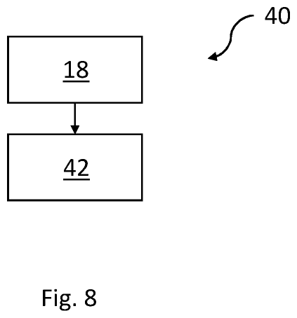

FIG. 8 illustrates a flow diagram of a method 40 of controlling a wind park. The wind park may comprise a plurality of wind turbines 1, each wind turbine 1 having a polarising light compass 7.

Step 18 shows estimation of an orientation relative to a fixed direction of each wind turbine. The steps which provide the estimation of the orientation relative to a fixed direction are those described above in relation to FIGS. 6 and 7.

The method proceeds to step 42, at which the plurality of wind turbines are aligned based on the estimated relative orientation of each wind turbine. The alignment may be calculated using an algorithm capable of substantially maximising the output of the wind park based on the prevailing wind direction and assuming all wind turbines in a wind park are orientated in the same direction.

The plurality of wind turbines does not necessarily represent all the wind turbines in the wind park. The plurality of wind turbines may for example comprise substantially half of the wind turbines in a wind park or any number necessary to align the majority of the wind turbines, or enough wind turbines to gain an appreciative efficiency boost in comparison a wind park not implementing the method of the application. The plurality of wind turbines running the method of the application may be on the edges of the wind park, or most likely affected by orientation inaccuracies.

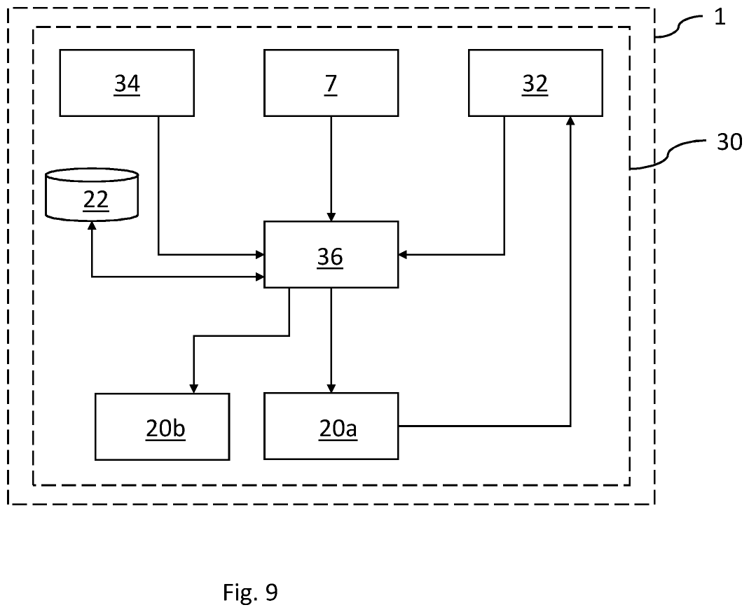

FIG. 9 illustrates a system diagram of a wind turbine control system 30 on or in the vicinity of the wind turbine 1. The wind turbine control system 30 illustrates specific components of the control system 100 of FIG. 2. The system 30 comprises: a yaw sensor encoder 32 configured to output a current yaw angle; a polarising light compass 7 configured to generate a sun polarisation value; a wind turbine controller communicatively connected to the polarising light compass 7 and the yaw sensor encoder 32. The wind turbine controller is configured to execute the method of the application as described above in relation to FIGS. 6 and 7.

The yaw sensor encoder 32 may be any type of encoder such as a mechanical absolute encoder; an optical absolute encoder; a magnetic absolute encoder; motor commutation; capacitive absolute encoder: absolute multi-turn encoder; rotary incremental encoder; a strain gauge; or any other method apparent to the person skilled in the art.

The control system 30 may also comprise a measurement unit 34 such as a clock. This may enable the measurements (e.g. sun polarisation value, light intensity, and/or yaw angle) to be associated with one another, and further for selection of appropriate sun orientation with relation to the fixed position from the solar polarisation model, look-up table, and/or any known method known in the art. The measurement unit 34 may be used in conjunction with the solar polarisation model in order to give an estimation of the sun direction at the time of measurement, this allows for a more accurate determination of the fixed direction and further still the difference between the angle of the polarising light compass 7 and the fixed direction.

Previously determined sun direction vectors may be stored on memory 22 (the memory 22 may be volatile or non-volatile) and the memory 22 may on/in the wind turbine, be remote from the wind turbine, and further still remote from the wind turbine geographical area. The memory 22 may store the associated data of the sun direction vectors (e.g. sun polarisation value, yaw angle, light intensity, etc.). The memory 22 may comprise a look-up table architecture or an alternative way of accessing the information on memory 22.

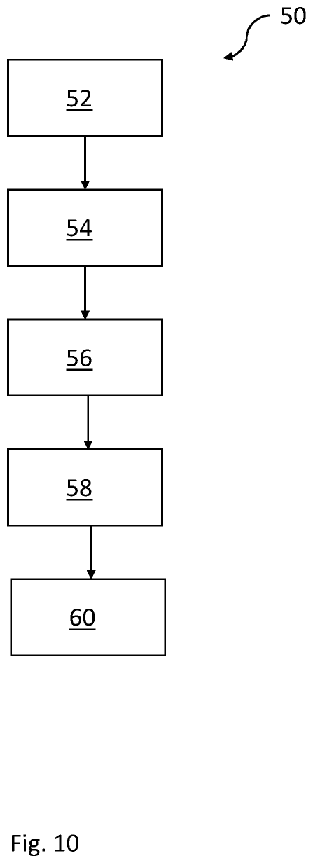

FIG. 10 illustrates a flow diagram of the method of calibrating a yaw angle of the wind turbine 50.

At step 52 a sun polarisation value at a measurement time is determined, using a polarising light compass of the wind turbine.

At step 54 an expected polarisation value is determined based on an expected position of the sun at the measurement time.

At step 56 the measured sun polarisation value is compared to the expected polarisation value.

At step 58 a yaw angle of the wind turbine is determined based on the comparison of the measured sun polarisation vector and expected polarisation value.

At step 60 the determined yaw angle is compared to a yaw angle generated by a yaw encoder of the wind turbine, in order to calibrate the yaw angle.

The present invention can also be implemented as a computer program product comprising software code adapted to control the wind turbine when executed on a data processing system, which is adapted to perform the method of the application as described above in relation to FIGS. 6 and 7.

Although the present invention has been described in connection with the specified embodiments, it should not be construed as being in any way limited to the presented examples. The invention can be implemented by any suitable means; and the scope of the present invention is to be interpreted in the light of the accompanying claim set. Any reference signs in the claims should not be construed as limiting the scope.

Example embodiments of the invention have been described for the purposes of illustration only, and not to limit the scope of the invention as defined in the accompanying claims.

1. A method of estimating an orientation of a wind turbine, the method comprising:
determining, using a polarising light compass of the wind turbine, a sun polarisation value;
determining a yaw angle of the wind turbine associated with the sun polarisation value;
determining a sun direction vector based on the sun polarisation value and the associated yaw angle; and
estimating an orientation of the wind turbine relative to a fixed direction using the sun direction vector.

2. The method of claim 1, further comprising generating a plurality of sun direction vectors based on determining a plurality of sun polarisation values; and
wherein the orientation is estimated using the plurality of sun direction vectors.

3. The method of claim 1, wherein determining the sun direction vector comprises comparing the sun polarisation value to a solar polarisation model.

4. The method of claim 1, wherein estimating an orientation of the wind turbine comprises comparing the sun direction vector to an expected trajectory of the sun.

5. The method of claim 1, wherein estimating the orientation of the wind turbine comprises comparing the sun direction vector to previous sun direction vectors.

6. The method of claim 1, wherein estimating the orientation of the wind turbine is further based on a measurement time associated with the sun polarisation value and/or a location of the wind turbine.

7. The method of claim 1, further comprising:
receiving a light intensity measurement associated with the sun polarisation value;
comparing the light intensity measurement to a predetermined threshold; and
if the light intensity measurement is less than the predetermined threshold, disregarding the sun polarisation value.

8. The method of claim 1, wherein the estimated orientation of the wind turbine is further based on previously estimated orientations of the wind turbine.

9. The method of claim 1, further comprising controlling the wind turbine based on the estimated orientation.

10. The method of claim 9, wherein controlling the wind turbine based on the estimated orientation comprises:
aligning the wind turbine with a wind direction; and/or
aligning the wind turbine with other wind turbines of a wind park.

11. The method of claim 9, wherein controlling the wind turbine based on the estimated orientation comprises:
predicting an area of shadow cast by the wind turbine based on wind turbine location, and the location of the sun; and
suspending operation of the wind turbine if the predicted wind turbine shadow falls within a restricted area.

12. The method of claim 1, wherein determining the sun polarisation value comprises:
detecting sunlight through a first polarisation filter and a second polarisation filter, wherein the first polarisation filter and the second polarisation filter have a fixed angle between them; and
comparing the sunlight detected through the first polarisation filter to the sunlight detected through the second polarisation filter.

13. A method of controlling a wind park, the wind park comprising a plurality of wind turbines, each wind turbine having a polarising light compass, the method comprising:
estimating an orientation relative to a fixed direction of each wind turbine of the plurality of wind turbines using the method of claim 1; and
aligning the plurality of wind turbines based on the estimated relative orientation of each wind turbine.

14. A method of calibrating a yaw angle of a wind turbine, the method comprising:
determining, using a polarising light compass of the wind turbine, a sun polarisation value at a measurement time;
determining an expected polarisation value based on an expected position of the sun at the measurement time;
comparing the measured sun polarisation value to the expected polarisation value;
determining a yaw angle of the wind turbine based on the comparison of the measured sun polarisation vector and expected polarisation value; and
comparing the determined yaw angle to a yaw angle generated by a yaw encoder of the wind turbine.

15. A wind turbine control system, the system comprising:
a yaw sensor encoder configured to output a current yaw angle;
a polarising light compass configured to generate a sun polarisation value; and
a wind turbine controller communicatively connected to the polarising light compass and the yaw sensor encoder,
wherein the wind turbine controller is configured to perform the method of claim 1.

16. A wind turbine comprising the wind turbine control system of claim 15, the wind turbine comprising:
a nacelle, wherein the polarising light compass is fixed to the external surface of the nacelle.

17. A computer program product comprising software code adapted to control a wind turbine when executed on a data processing system, the computer program product being adapted to perform the method of claim 1.
